(19) United States
(12) Patent Application Publication
(10) Pub. No.: US 2016/0001251 A1
(43) Pub. Date: Jan. 7, 2016

(54) RUPTURABLE RELIABILITY DEVICES FOR CONTINUOUS FLOW REACTOR ASSEMBLIES

(71) Applicant: CORNING INCORPORATED, Corning, NY (US)

(72) Inventor: Khaled Layouni, Moncourt-Fromonville (FR)

(21) Appl. No.: 14/768,639

(22) PCT Filed: Feb. 20, 2014
(86) PCT No.: PCT/US2014/017255

§ 371 Date: Aug. 18, 2015

Related U.S. Application Data
(60) Provisional application No. 61/768,058, filed on Feb. 22, 2013.

(51) Int. Cl. B01J 19/00; G05D 7/06; G05B 15/02

(52) U.S. Cl. CPC B01J 19/0093; B01J 19/0006; G05B 15/02; G05D 7/0629; B01J 2219/0095; B01J 2219/00824; B01J 2219/00831; B01J 2219/0079

(57) ABSTRACT

A flow reactor assembly (10) includes a fluidic module (12,14,16) which include a module body (18) having an internal flow path (20) in communication with an inlet (22) and an outlet (28) and a module burst pressure. A pressure relief valve (36,38,40) relieve pressure within the fluidic module (12,14,16). The pressure relief valves (36,38,40) have a relief pressure value that is less than the module burst pressure. Rupturable reliability devices (50,52,54,56) have a fluid passageway extending therethough through which fluid is received from or directed to the fluidic module (12,14,16). The rupturable reliability device (50,52,54,56) includes a tubular body having a device burst pressure that is greater than the relief valve pressure value (36,38,40) and less than the module burst pressure (12,14,16).

### CROSS-REFERENCE TO RELATED APPLICATIONS

This application claims the benefit of priority under 35 U.S.C. §119 of U.S. Provisional Application Ser. No. 61/768,058 filed on Feb. 22, 2013, the content of which is relied upon and incorporated herein by reference in its entirety.

### FIELD

The present disclosure relates generally to continuous flow reactor assemblies and, more particularly, to rupturable reliability devices for continuous flow reactor assemblies that are used to reduce pressures during reactions.

### BACKGROUND

Flow reactor assemblies allow for the processing of chemical compounds with a high degree of control of reaction parameters. The flow reactor assemblies are often made with an assembly of several individual or multiple stacked fluidic modules. A pressure drop through the flow reactor assemblies results from application of a desired flow rate or residence time within the fluidic modules.

Under normal operating conditions, pressures within the flow reactor assemblies may be controlled, at least to some extent, using pressure relief valves. However, due to use of certain products, chemical reactions and/or reaction conditions, reaction runaway may lead to rapid increases in pressure within the flow reactor assemblies. In these instances, the pressure relief valves may not be able to relieve the pressures within the fluidic modules to an acceptable maximum pressure value.

In an attempt to mitigate issues presented by high pressure reactions, the flow reactor assemblies may be located in a predetermined isolated location and/or may be covered with a shock resistant plastic container made of PMMA or polycarbonate for example. In some cases, the fluidic modules may be protected by covering them individually by a resilient material (plastic or rubber foam). These approaches may mitigate some of the issues but do not prevent the pressure increase (until reaching the strength value of the fluidic modules). Moreover, even some fluidic modules that do not break during a high-pressure incident may have seen high pressures for a given duration and consequently ageing could be accelerated inducing a lifetime decrease.

### SUMMARY

In one embodiment, a flow reactor assembly includes a fluidic module comprising a module body having an internal flow path in communication with an inlet and an outlet and a module burst pressure. A pressure relief valve relieves pressure within the fluidic module. The pressure relief valve has a relief pressure value that is less than the module burst pressure. A rupturable reliability device has a fluid passageway extending therethough through which fluid is received from or directed to the fluidic module. The rupturable reliability device includes a tubular body having a device burst pressure that is greater than the relief valve pressure value and less than the module burst pressure.

In another embodiment, a method of controlling pressure within a flow reactor assembly is provided. The method includes connecting a rupturable reliability device to a fluidic module comprising a module body having an internal flow path and a module burst pressure. A pressure relief valve is connected to the fluidic module that relieves pressure within the fluidic module. The pressure relief valve has a relief pressure value that is less than the module burst pressure. Fluid is directed through the internal flow path to the rupturable reliability device. A tubular body of the rupturable reliability device is ruptured when a device burst pressure of the tubular body is exceeded. The device burst pressure being greater than the relief valve pressure value and less than the module burst pressure.

In another embodiment, a flow reactor assembly includes a fluidic module comprising a module body having an internal flow path in communication with an inlet and an outlet and a module burst pressure. A rupturable reliability device has a fluid passageway through which fluid is received from or directed to the fluidic module. The rupturable reliability device includes a tubular body having a device burst pressure that is less than the module burst pressure.

Additional features and advantages of the claimed subject matter will be set forth in the detailed description which follows, and in part, will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic illustration of an embodiment of a flow reactor assembly including a rupturable reliability device;

FIG. 2 is a schematic illustration of another embodiment of a flow reactor assembly;

FIG. 3 is a schematic illustration of another embodiment of a flow reactor assembly;

FIG. 4 is a section view of an embodiment of a rupturable reliability device;

FIG. 5 is a section view of another embodiment of a rupturable reliability device;

FIG. 6 is a section view of another embodiment of a rupturable reliability device;

FIG. 7 is a perspective view of an embodiment of a tubular body of a rupturable reliability device;

FIG. 8 is a perspective view of another embodiment of a tubular body of a rupturable reliability device;

FIG. 9 is a perspective view of another embodiment of a tubular body of a rupturable reliability device;

FIG. 10 is a perspective view of another embodiment of a tubular body of a rupturable reliability device;

FIG. 11 is a partial, section view of an embodiment of a tubular body having a monolithic construction;

FIG. 12 is a partial, section view of an embodiment of a tubular body having a multi-layer construction;

FIG. 13 is a partial, section view of an embodiment of a tubular body having a coating material;

FIG. 14 is a schematic illustration of an embodiment of a rupturable reliability device at least partially enclosed within a sealing member;

FIG. 15 is another schematic illustration of the rupturable reliability device of FIG. 14 within the sealing member; and

FIG. 16 is a schematic illustration of another embodiment of a rupturable reliability device at least partially enclosed within a sealing member.

### DETAILED DESCRIPTION

Embodiments described herein generally relate to devices for processing fluids, such as a reactor or heat exchanger, or combination reactor and heat exchanger, collectively referred to herein as flow reactor assemblies. The flow reactor assemblies may include multiple fluidic modules that include microstructure bodies forming internal flow paths through the fluidic modules. Adjacent fluidic modules may be connected to allow fluid flow therebetween by one or more conduits. Pumps and other flow devices may be used to direct fluids through the conduit and the interconnected fluidic modules. During operation, pressures within the conduit and the fluidic modules may rise and fall, at least in part, due to chemical or other reactions that occur within the flow reactor assembly. Accordingly, pressure relief valves may be used to control the pressures within the conduit and the fluidic modules. As will be described in greater detail below, rupturable reliability devices may be provided to relieve relatively high pressures, above those pressures controllable by the pressure relief valves.

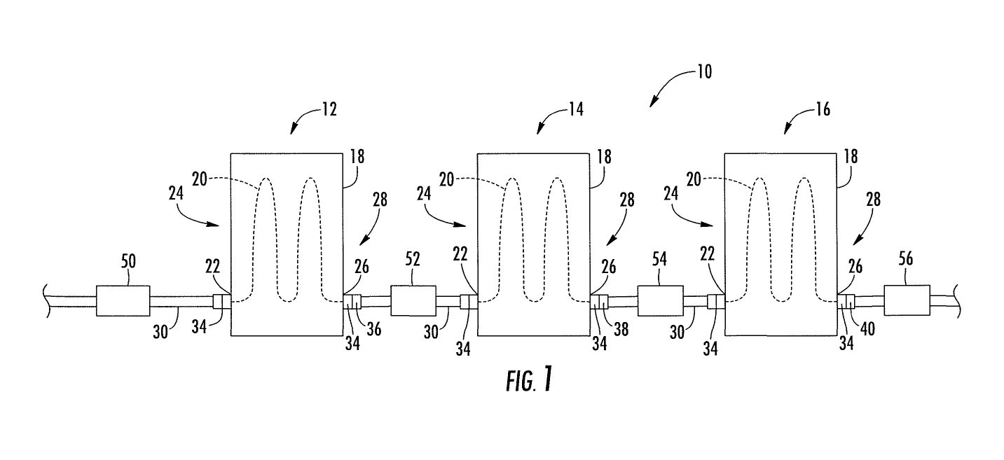

Referring to FIG. 1, a flow reactor assembly 10 includes multiple fluidic modules 12, 14 and 16. The fluidic modules 12, 14 and 16 are illustrated in a side-by-side, horizontal arrangement, however, other arrangements are possible, such as stacked and/or offset arrangements. Additionally, while three fluidic modules 12, 14 and 16 are illustrated, more or less than three fluidic modules may be used. Each fluidic module 12, 14 and 16 may be formed of an extruded module body 18 or monolith having multiple elongated cells therein, defining the internal flow paths 20 of the fluidic modules 12, 14 and 16. Various fluidic module structures are described in detail in U.S. Pat. No. 8,197,769 entitled EXTRUDED BODY DEVICES AND METHODS FOR FLUID PROCESSING and U.S. Pat. No. 8,211,376 entitled DEVICES AND METHODS FOR HONEYCOMB CONTINUOUS FLOW REACTOR ASSEMBLIES, the details of both of which are hereby incorporated herein by reference.

Each fluidic module 12, 14 and 16 includes an inlet port 22 located at an inlet side 24 and an outlet port 26 located at an outlet side 28. While a single inlet port 22 and outlet port 26 are illustrated for each fluidic module 12, 14 and 16, multiple inlet and/or outlet ports may be used. Fluid conduits 30 may be used to connect adjacent fluidic modules 12, 14 and 16 and allow fluid flow therebetween. The fluid conduits 30 may also allow for connection to other devices, such as a pump, which allow and/or regulate fluid flow through the flow reactor assembly 10. Fittings or other connectors 34, such as clamps, may be used to connect the fluid conduits 30 to the fluidic modules 12, 14 and 16 in a fluid-tight manner Any suitable materials may be used for the fluid conduits 30, such as polytetrafluoroethylene (PTFE).

One or more of the fluid conduits 30 (and the fluidic modules 12, 14 and 16) may be connected to pressure relief valves 36, 38 and 40. In the illustrated embodiment, the pressure relief valves 36, 38 and 40 are located near the outlet ports 26 of the fluidic modules 12, 14 and 16; however, the pressure relief valves 36, 38 and 40 may be located near the inlet ports 22 or in direct communication with the internal flow paths of the fluidic modules 12, 14 and 16. Any suitable pressure relief valves may be used such as proportional relief valves, commercially available from Swagelok Company. Flow control valves may also be used.

The pressure relief valves 36, 38 and 40 may be used to control (i.e., reduce) pressure within the fluid conduits 30 and the fluidic modules 12, 14 and 16 by allowing the pressurized fluid to escape from its associated fluid conduit 30 to a controlled environment or to the atmosphere. The pressure relief valves 36, 38 and 40 may attempt to keep the pressure within the fluid reactor assembly 10 below a particular maximum operating pressure OPₘₐₓ. As used herein, the “maximum operating pressure” refers to the maximum pressure that the weakest component of the fluid reactor assembly 10 can safely withstand during normal operation and can be determined using any suitable testing process, such as computer modeling or experimentation. Exemplary maximum operating pressures OPₘₐₓ for the fluid reactor assembly 10 may be between about 10 bars and about 50 bars, such as between about 15 bars and about 30 bars. However, the maximum operating pressure may be significantly higher than this, as particularly robust fluid reactor assemblies may have maximum operating pressures of as high as 250 bars or more. As one non-limiting example, a maximum operating pressure OPₘₐₓ for the flow reactor assembly 10 may be about 18 bars. The pressure relief valves 36, 38 and 40 may have a set pressure or relief valve pressure value Pᵥₐₗᵥₑ at or above the maximum operating pressure OPₘₐₓ. As used herein, the “relief valve pressure value” refers to the pressure at which the pressure relief valve 36, 38, 40 will open and “blowdown” refers to the pressure drop at which the pressure relief valve 36, 38, 40 will close, often expressed as a percentage of the relief valve pressure value. For example the relief valve pressure value Pᵥₐₗᵥₑ may be within about 0 to 10 bars higher than the maximum operating pressure OPₘₐₓ. As one non-limiting example, the relief valve pressure value Pᵥₐₗᵥₑ may be about 2 bars higher than the maximum operating pressure OPₘₐₓ, such as about 20 bars and the blowdown may be between about 2 and about 20 percent.

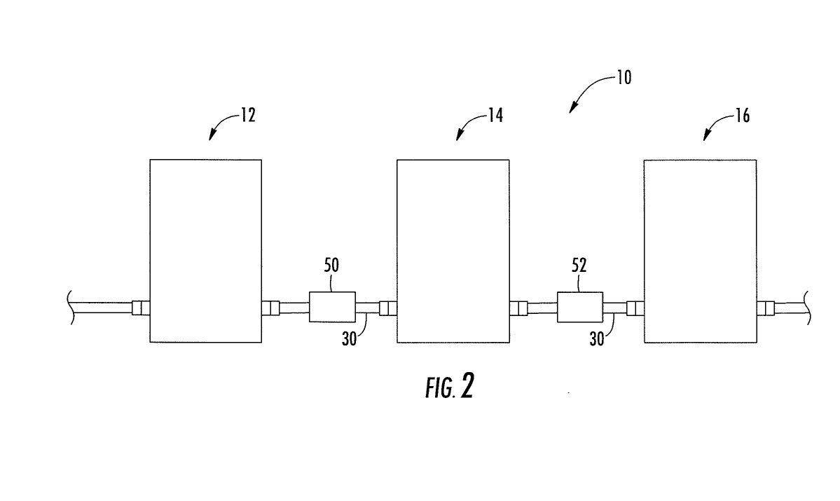

Due to the use of particular products, chemical reactions and/or conditions, pressure within the flow reactor assembly 10 may increase above that which can be handled by the pressure relief valves 36, 38 and 40. Rupturable reliability devices 50, 52, 54 and 56 may provide additional pressure relief in instances where the pressure rises above that which can be handled by the pressure relief valves 36, 38 and 40. In the illustrated example, the rupturable reliability devices 50, 52, 54 and 56 are located at both the inlet sides 24 and the outlet sides 28 of the fluidic modules 12, 14 and 16. Referring briefly to FIG. 2, in other embodiments, rupturable reliability devices 50 and 52 may be located at only certain positions, such as at more sensitive flow reactor assembly 10 locations (e.g., where reaction runaway and/or where liquid projection may be more likely within the flow reactor assembly). Additionally, while the rupturable reliability devices 50, 52, 54 and 56 are illustrated between conduits 30, the rupturable reliability devices may be connected directly to the fluidic modules 12, 14 and 16, as shown by FIG. 3.

Referring again to FIG. 1, the rupturable reliability devices 50, 52, 54 and 56 may be selected to have a brittleness the same or similar to that of the fluidic modules 12, 14 and 16, but have a lower strength and burst pressure. In these embodiments, one or more of the rupturable reliability devices 50, 52, 54 and 56 may attempt to maintain or lower the pressure within the fluid reactor assembly 10 below a module burst pressure P_{FM}, yet not operate until pressures rise above the relief valve pressure value Pᵥₐₗᵥₑ. As used herein, the term “burst pressure” is the point at which a component will fail (e.g., rupture or break) as a result of pressure and can be determined using any suitable process, such as through experimentation or computer modeling. Exemplary module burst pressures P_{FM} may be between about 30 bars and about 75 bars, such as about 50 bars, or for high pressure modules, between about 100 and 250 bars, such as about 175 bars. In either case, the minimum and maximum selectable burst pressures for a reliability device P_{RD} may be given by:

Pᵥₐₗᵥₑ+p₁≦P_{RD}≦P_{FM}−p₂

where p₁ and p₂ are pressure safety values, selectable based, at least in part, on particular reactions and other fluid reactor assembly conditions. As one example, p₁ and p₂ may be between about 2 and 10 bars, such as about 5 bars and may be the same or different values.

The above equation uses the relief valve pressure value Pᵥₐₗᵥₑ and the module burst pressure P_{FM} in calculating the lower and upper limits of the device burst pressures P_{RD}, respectively, for the rupturable reliability device. However, other values may be used. For example, the maximum operating pressure OPₘₐₓ times a safety factor SF (e.g., between 1 and 5, such as 2) may be used as the lower limit. Utilizing the maximum operating pressure OPₘₐₓ can allow for determining a lower P_{RD} limit above that of the relief valve pressure value Pᵥₐₗᵥₑ, which can reduce the possibility of premature rupturing of the rupturable reliability devices within pressure values at or near those that can be handled by the pressure relief valves 36, 38 and 40. In some embodiments, it may be desirable to use a value other than the module burst pressure P_{FM} in calculating the upper limit on the reliability device burst pressure P_{RD}. It may be the case, for example, that the fluidic modules 12, 14, 16 have a module burst pressure P_{FM} that is higher than those of many or all the components of the fluid reactor assembly 10 and use of a lower pressure value may be desired. For example, a particular maximum working pressure WPₘₐₓ may be used in determining the upper limit. As used herein, the “maximum working pressure” refers to the maximum pressure that the weakest component of the fluid reactor assembly 10 can handle without damage and can be determined using any suitable testing process, such as computer modeling or experimentation. In many cases, the maximum working pressure WPₘₐₓ is greater the maximum operating pressure OPₘₐₓ. In some embodiments, it may be desirable to use the maximum working pressure WPₘₐₓ in determining the upper limit on the reliability device burst pressure P_{RD} to avoid damage to any of the other components of the fluid reactor assembly 10.

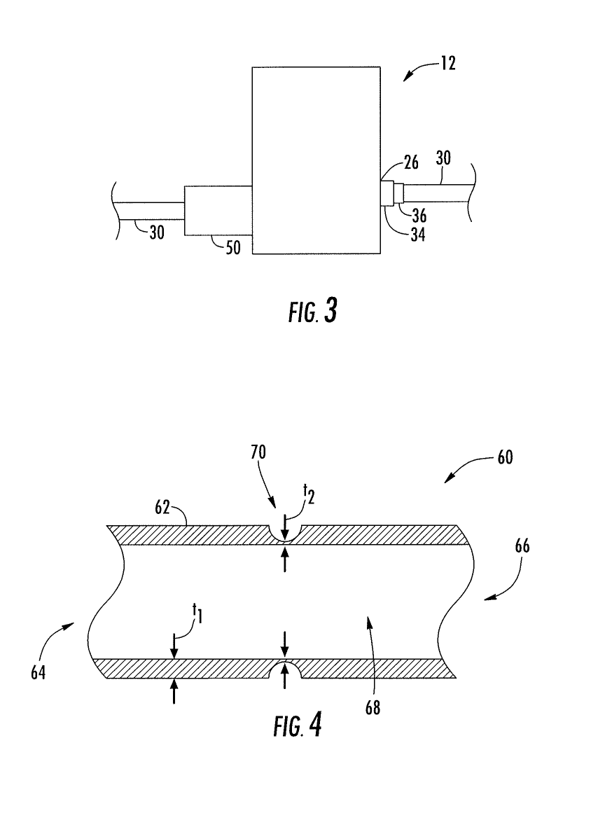

FIGS. 4-6 illustrate various rupturable reliability device examples detailing weakening structures to reduce their strength and burst pressure (compared to without the weakening structures). Referring first to FIG. 4, a rupturable reliability device 60 is formed of a tubular body 62 having an inlet end 64, an outlet end 66 and a fluid passageway 68 that delivers pressurized fluid from the inlet end 64 to the outlet end 66. The tubular body 62 has a relatively constant wall thickness t₁, except for at a weakening structure 70, which is formed by a region of less wall thickness t₂ thereby reducing the device burst pressure P_{RD}. Referring to FIG. 5, a rupturable reliability device 72 is formed of a tubular body 74 also having an inlet end 76, an outlet end 78 and a fluid passageway 80 that delivers pressurized fluid from the inlet end 76 to the outlet end 78. In this exemplary embodiment, the tubular body 74 may (or may not have) a substantially constant wall thickness t with a weakening structure 82 in the form of a region of increased inner diameter D₂ in a central region C compared to inner diameters D₁ in end regions E₁ and E₂. The weakening structure 82 of increased inner diameter D₂ provides a region of higher pressure that can rupture under predetermined pressure conditions. In some embodiments, regions R₁ and R₂ of increasing and decreasing diameter, respectively, may be provided to provide a relatively smooth transition from D₁ to D₂ and back to D₁. In other embodiments, regions R₁ and R₂ may not be provided and vertical step downs in diameter may be used. Referring now to FIG. 6, a rupturable reliability device 90 is formed of a tubular body 92 having an inlet end 94, an outlet end 96 and a fluid passageway 98 that delivers pressurized fluid from the inlet end 94 to the outlet end 96. The tubular body 92 has a relatively constant wall thickness t and a weakening structure 100, which is formed by a local defect 102 (e.g., a crack induced by scratching, cutting, impacting, etc.) thereby reducing the device burst pressure P_{RD}.

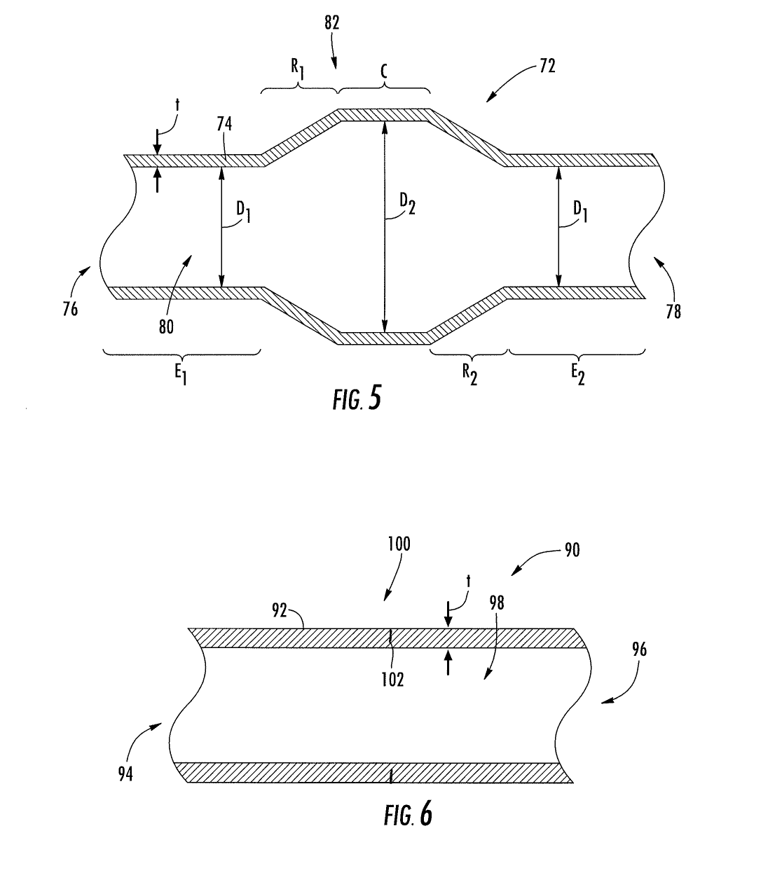

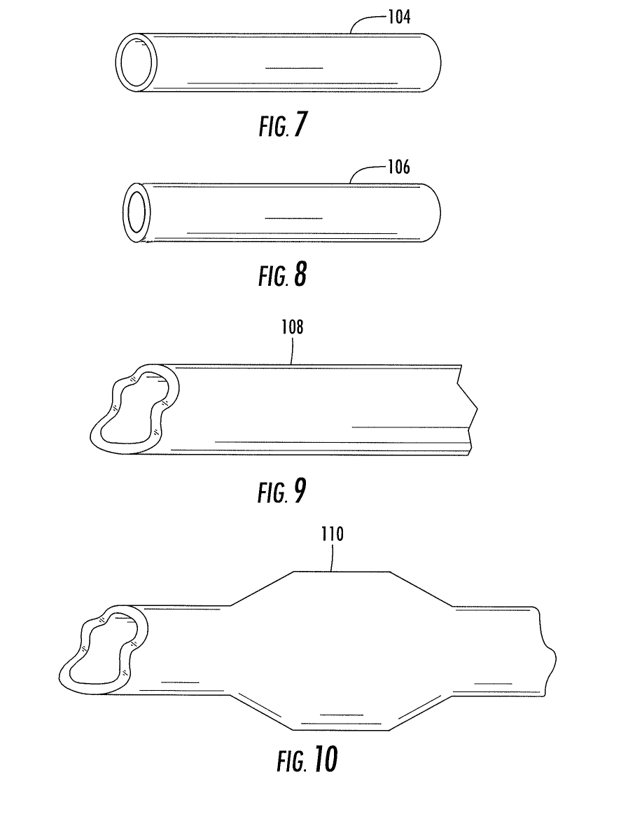

FIGS. 7-10 illustrate some exemplary tubular body configurations for the rupturable reliability devices. FIG. 7, for example, illustrates a somewhat straight tubular body 104 with a constant circular section, FIG. 8 illustrates a straight tubular body 106 with a non-circular cross section (e.g., oval) and FIG. 9 illustrates a straight tubular body 108 with any given cross-sectional shape. These straight tubular bodies 104, 106 and 108 may be nicked, scratched, impacted or machined to form a local defect (FIG. 6) or a region of lesser wall thickness (FIG. 4), as examples. FIG. 10 illustrates a tubular body 110 having a non-constant cross section and variable outer and inner diameter. This tubular body 110 may be used to form the rupturable reliability device 90 (FIG. 5). The tubular body 110 may also be nicked, scratched, impacted, machined or otherwise altered to form a local defect or a region of lesser wall thickness. Other configurations are possible, such as varying only the inner diameter of the tubular bodies, while the outer diameter remains constant.

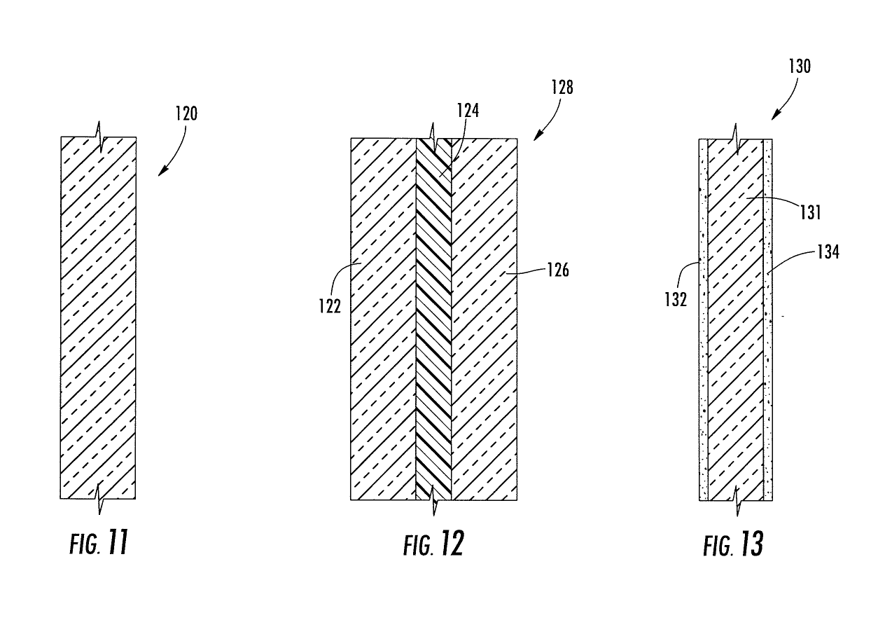

Any suitable materials may be used for forming the rupturable reliability devices that, for example, provide the reliability device burst pressures P_{RD} discussed above and that are compatible with the specific reactions and processes employed. Referring to FIG. 11, a monolithic tubular body 120 may be used, formed of a single material (e.g., glass, glass-ceramic, ceramic, or a composite material). Multilayered materials (e.g., having layers 122, 124 and 126) may be used to form a tubular body 128. As one example, the layers 122 and 126 may be a glass, glass-ceramic or a composite material (materials of relatively high brittleness) and layer 24 may be a polymer, rubber or some other type of material (materials of relatively low brittleness), as shown by FIG. 12. FIG. 13 illustrates a coated tubular body 130 formed of a structure layer 131 that is coated with coatings 132 and 134. The coatings 132 and 134 may be the same or different materials. Suitable coating materials may include perfluoro-alkoxy (PFA), polytetrafluoroethylene (PTFE), polyetheretherketone (PEEK), polyvinylidene difluoride (PVDF), polycarbonate (PC), elastomers, etc.

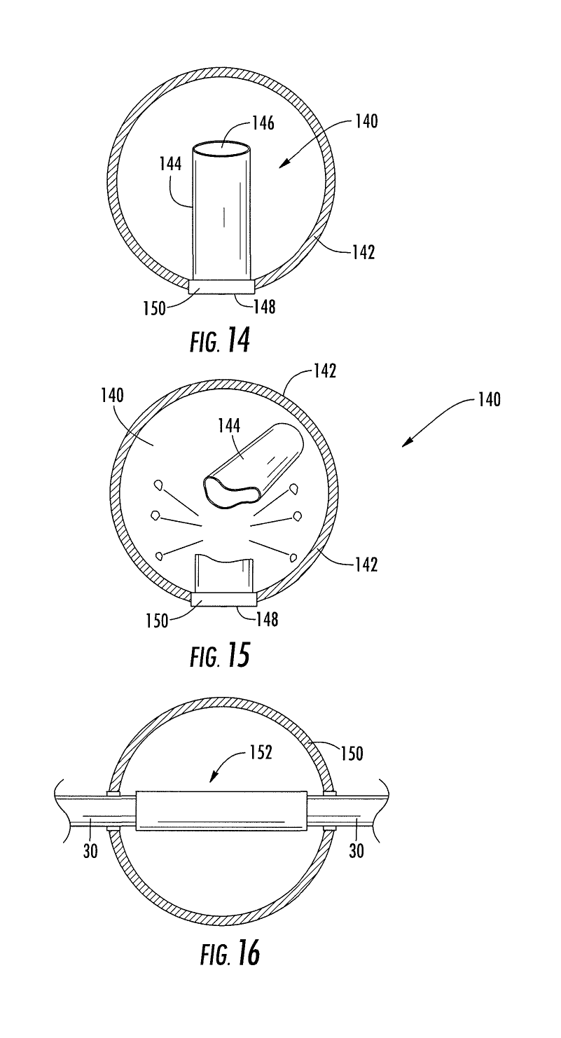

Referring to FIGS. 14 and 15, a rupturable reliability device 140, which can include any one or more of the features described above, is illustrated at least partially enclosed or surrounded by a sealing member 142. FIG. 14, for example, illustrates the rupturable reliability device 140 in an unruptured configuration having a tubular body 144 having a closed end 146 and an open end 148 (e.g., that is connected to the conduit 30 and/or the fluidic modules 12, 14, 16). A connector device 150, such as a clamp, adhesive or other connector device may be used to connect the sealing member 142, in a fluid-tight fashion, to the tubular body 144. FIG. 15 illustrates the rupturable reliability device 140 in a ruptured configuration, releasing pressure. The sealing member 142 may be formed of a material that prevents escape of the fluids into the atmosphere. The sealing member may also be formed of a flexible and expandable material (e.g., rubber or plastic film or bag) to accommodate increasing fluid pressure within the sealing member. In other embodiments, a rigid container may be used as the sealing member 142. Referring to FIG. 16, another configuration is illustrated where a sealing member 150 is clamped or otherwise connected about a rupturable reliability device 152 in an in-line configuration.

The above-described rupturable reliability devices and their use in flow reactor assemblies can provide improved reliability of microreactor products. The rupturable reliability devices can be employed where runaway may occur increasing pressure to an extent that the pressure relief valves are unable to release the pressure at a high enough rate to prevent damage to components of the flow reactors. While embodiments described above include use of pressure relief valves, the reliability devices described herein may be used in flow reactor assemblies without pressure relief valves.

It will be apparent to those skilled in the art that various modifications and variations can be made to the embodiments described herein without departing from the spirit and scope of the claimed subject matter. Thus, it is intended that the specification cover the modifications and variations of the various embodiments described herein, provided such modification and variations come within the scope of the appended claims and their equivalents.

1. A flow reactor assembly comprising:
a fluidic module comprising a module body having an internal flow path in communication with an inlet and an outlet and a module burst pressure;
a pressure relief valve that relieves pressure within the fluidic module, the pressure relief valve having a relief pressure value that is less than the module burst pressure; and
a rupturable reliability device having a fluid passageway extending therethough through which fluid is received from or directed to the fluidic module, the rupturable reliability device including a tubular body having a device burst pressure that is greater than the relief valve pressure value and less than the module burst pressure.

2. The flow reactor assembly of claim 1, wherein the device burst pressure is between about 25 bars and about 45 bars.

3. The flow reactor assembly of claim 1, wherein the module burst pressure is between about 30 bars and about 75 bars.

4. The flow reactor assembly of claim 1, wherein the relief pressure valve value is between about 15 and about 40 bars.

5. The flow reactor assembly of claim 1, wherein the tubular body has a circular cross-sectional shape.

6. The flow reactor assembly of claim 1, wherein the tubular body has a non-circular cross-sectional shape.

7. The flow reactor assembly of claim 1, wherein a width of the fluid passageway is constant along a length of the tubular body.

8. The flow reactor assembly of claim 1, wherein a width of the fluid passageway varies along a length of the tubular body.

9. The flow reactor assembly of claim 1, wherein the tubular body includes a weakening structure.

10. The flow reactor assembly of claim 9, wherein the weakening structure comprises a region of reduced wall thickness.

11. The flow reactor assembly of claim 9, wherein the weakening structure comprises a local defect in the tubular body.

12. The flow reactor assembly of claim 1, wherein the tubular body is formed of a monolithic material.

13. The flow reactor assembly of claim 1, wherein the tubular body is formed of a glass, ceramic or a combination of glass and ceramic.

14. The flow reactor assembly of claim 1, wherein the tubular body is formed of multiple layers.

15. The flow reactor assembly of claim 14, wherein the tubular body comprises a first layer having a first brittleness and a second layer having a second brittleness, the first brittleness being less than the second brittleness.

16. The flow reactor assembly of claim 1, wherein the tubular body comprises a coating material.

17. The flow reactor assembly of claim 1 further comprising a sealing member at least partially enclosing the rupturable reliability device.

18. A method of controlling pressure within a flow reactor assembly, the method comprising:
connecting a rupturable reliability device to a fluidic module comprising a module body having an internal flow path and a module burst pressure;
providing a pressure relief valve that relieves pressure within the fluidic module, the pressure relief valve having a relief pressure value that is less than the module burst pressure;
directing fluid through the internal flow path to the rupturable reliability device; and
rupturing a tubular body of the rupturable reliability device when a device burst pressure of the tubular body is exceeded, the device burst pressure being greater than the relief valve pressure value and less than the module burst pressure.

19. The method of claim 18, wherein the device burst pressure is between about 25 bars and about 45 bars.

20. The method of claim 18, wherein the module burst pressure is between about 30 bars and about 75 bars.

21. The method of claim 18, wherein the relief pressure valve value is between about 15 and about 40 bars.

22. The method of claim 18 comprising providing the tubular body with a circular cross-sectional shape.

23. The method of claim 18 comprising providing the tubular body with a non-circular cross-sectional shape.

24. The method of claim 18 comprising providing the fluid passageway with a constant width along a length of the tubular body.

25. The method of claim 18 comprising providing the fluid passageway with a varying width along a length of the tubular body.

26. The method of claim 18 comprising providing the tubular body with a weakening structure.

27. The method of claim 26, wherein the weakening structure comprises a region of reduced wall thickness.

28. The method of claim 26, wherein the weakening structure comprises a local defect in the tubular body.

29. The method of claim 18 comprising forming the tubular body of a monolithic material.

30. The method of claim 18 comprising forming the tubular body of a glass, ceramic or a combination of glass and ceramic.

31. The method of claim 18 comprising forming the tubular body of multiple layers.

32. The method of claim 31, wherein the tubular body comprises a first layer having a first brittleness and a second layer having a second brittleness, the first brittleness being less than the second brittleness.

33. The method of claim 18 comprising coating the tubular body with a coating material.

34. The method of claim 18 further comprising enclosing the rupturable reliability device with a sealing member.

35. A flow reactor assembly comprising:
a fluidic module comprising a module body having an internal flow path in communication with an inlet and an outlet and a module burst pressure; and
a rupturable reliability device having a fluid passageway through which fluid is received from or directed to the fluidic module, the rupturable reliability device including a tubular body having a device burst pressure that is less than the module burst pressure.

36. The flow reactor assembly of claim 35 further comprising a sealing member at least partially enclosing the rupturable reliability device.

37. The flow reactor assembly of claim 36, wherein the sealing member comprises a flexible bag.

38. The flow reactor assembly of claim 36, wherein the sealing member comprises a rigid container.
